(19) United States
(12) Patent Application Publication
(10) Pub. No.: US 2014/0193557 A1
(43) Pub. Date: Jul. 10, 2014

(54) Method of Producing Processed Brown Rice

(71) Applicants: Yuuki Nakayoshi, Koto-ku (JP); Hiroyuki Nakayama, Chiba-shi (JP); Yoji Kameo, Inzai-shi (JP)

(72) Inventors: Yuuki Nakayoshi, Koto-ku (JP); Hiroyuki Nakayama, Chiba-shi (JP); Yoji Kameo, Inzai-shi (JP)

(73) Assignee: Kao Corporation, Chuo-ku, Tokyo (JP)

(21) Appl. No.: 14/235,535

(22) PCT Filed: Jul. 26, 2012
(86) PCT No.: PCT/JP2012/069012

§ 371 Date: Jan. 28, 2014

(30) Foreign Application Priority Data
Jul. 28, 2011 (JP) 2011-165987

(51) Int. Cl. A23L 1/182

(52) U.S. Cl. CPC A23L 1/1826
USPC 426/461

(57) ABSTRACT

A method of producing processed brown rice, containing at least the steps of:
subjecting raw brown rice to heat-moisture treatment using water vapor having a temperature of from 110 to 150° C. for from 5 to 90 minutes; and
subjecting the brown rice after the heat-moisture treatment to heat treatment at a temperature of from 80 to 100° C. for from 5 to 90 minutes.

### FIELD OF THE INVENTION

The present invention relates to a method of producing processed brown rice.

### BACKGROUND OF THE INVENTION

In recent years, the prevalence of obesity among the populations of economically advanced societies has rapidly increased due to high-calorie eating habits. The rates of diabetes, arteriosclerosis, cardiopathy and other lifestyle-related diseases deeply related to obesity are steadily rising.

Then, 4,4-dimethylsterols are plant sterols present in rice and have been reported to have functions of preventing and improving various lifestyle-related diseases. For example, cycloartenol has been reported to function as an adiponectin secretagogue and to be useful as an anti-arteriosclerosis agent, an antiobesity agent, an antidiabetic agent and the like (for example, see Patent Literature 1). Moreover, 24-methylenecycloartanol has been reported to have functions of improving hyperglycemia and enhancing insulin sensitivity (for example, see Patent Literatures 2 and 3).

Meanwhile, applying heat-moisture treatment with water vapor to germinated brown rice and drying the resultant product has been reported to improve the texture and taste of brown rice (for example, see Patent Literature 4).

### CITATION LIST

### Patent Literatures

Patent Literature 1: JP-A-2005-68132 (“JP-A” means unexamined published Japanese patent application)
Patent Literature 2: Japanese Patent No. 3924310
Patent Literature 3: Japanese Patent No. 4176140
Patent Literature 4: JP-A-2004-49010

### SUMMARY OF THE INVENTION

The present invention provides a method of producing processed brown rice, containing at least the steps of:

subjecting raw brown rice to heat-moisture treatment using water vapor having a temperature of from 110 to 150° C. for from 5 to 90 minutes; and

subjecting the brown rice after the heat-moisture treatment to heat treatment at a temperature of from 80 to 100° C. for from 5 to 90 minutes.

Further, the present invention provides processed brown rice containing cycloartenol in an amount of 6.4 mg or more per 100 g of dried form of the processed brown rice.

Further, the present invention provides processed brown rice containing 24-methylenecycloartanol in an amount of 4.5 mg or more per 100 g of dried form of the processed brown rice.

Further, the present invention provides processed brown rice containing cycloartenol and 24-methylenecycloartanol in an amount of 11.0 mg or more in total per 100 g of dried form of the processed brown rice.

Other and further features and advantages of the present invention will appear more fully from the following description.

### DETAILED DESCRIPTION OF THE INVENTION

The present invention relates to provide a method of producing processed brown rice (unpolished rice) containing increased amount of cycloartenol or 24-methylenecycloartanol.

The present inventors diligently conducted a study based on the idea that an increase, if possible, in the content of cycloartenol or 24-methylenecycloartanol in brown rice would enable provision of brown rice useful for prevention and improvement of lifestyle-related diseases. As a result, the present inventors found that when raw brown rice is subjected to heat-moisture treatment and heat treatment at specific temperatures, the content of cycloartenol and 24-methylenecycloartanol in the raw brown rice increases. Moreover, boiled rice (steamed rice) obtained by boiling (steaming) the brown rice after these treatments had good flavor and texture. The present invention was completed based on these findings.

A method of producing processed brown rice according to the present invention (hereinafter, referred to as the production method of the present invention) is a method of producing processed brown rice containing increased amount of cycloartenol or 24-methylenecycloartanol in comparison with raw brown rice used as a raw material. The processed brown rice obtained by the production method of the present invention is suitable for boiling and consumption.

Hereinafter, the production method of the present invention is described in detail.

In the production method of the present invention, raw brown rice is used as a starting raw material. The raw brown rice used as the raw material is not particularly limited, and one kind or two or more kinds selected from non-waxy rice and waxy rice can be used. Moreover, as the non-waxy rice, one kind or two or more kinds selected from Japonica rice, Indica rice and a hybrid of the Japonica rice and the Indica rice is exemplified. A cultivar of the raw brown rice used as the raw material is not particularly limited, and for example, one kind or two or more kinds selected from Koshihikari, Hinohikari, Milky Queen, Sari Queen, Hitomebore, Akitakomachi and Yumetoiro being a general variety can be used.

To the raw brown rice being the raw material, heat-moisture treatment is applied using water vapor having specific temperature. The heat-moisture treatment in the present invention means heat treatment in the presence of water vapor, and is performed by bringing water vapor having the specific temperature into contact with target brown rice.

The raw brown rice is preferably washed according to an ordinary method before the heat-moisture treatment. Moreover, after washing, the raw brown rice may be soaked in water. Water temperature at which the raw brown rice is soaked in water is not particularly limited, but is preferably less than 15° C. from a viewpoint of suppressing growth of bacteria.

The temperature of water vapor in the heat-moisture treatment is from 110 to 150° C., preferably from 110 to 145° C., more preferably from 115 to 140° C., more preferably from 120 to 135° C., and more preferably from 125 to 135° C. When the temperature of water vapor in the heat-moisture treatment exceeds 150° C., singe easily occur on the surface of the brown rice, and appearance may be adversely affected.

Time for heat-moisture treatment of raw brown rice is within the range of from 5 to 90 minutes, and preferably from 20 to 90 minutes, more preferably from 30 to 70 minutes, and more preferably from 40 to 60 minutes. Ordinarily, higher temperature of the heat-moisture treatment allows further shortening of treatment time. The temperature of water vapor may be constant during the heat-moisture treatment, or may be varied.

Pressure of the heat-moisture treatment is preferably saturated vapor pressure.

The brown rice is subjected to heat-moisture treatment so that water content thereof is preferably from 20 to 70% by mass, more preferably from 25 to 50% by mass, and more preferably from 30 to 45% by mass, at the time of immediately after the heat-moisture treatment. The water content can be calculated by deducting the mass of absolutely dried brown rice that is absolutely dried immediately after the heat-moisture treatment, from the mass of the brown rice immediately after the heat-moisture treatment. The brown rice can be absolutely dried by being frozen in liquid nitrogen and then performing freeze drying (−80° C., 5 Pa, 48 hours).

Application of the heat-moisture treatment causes an increase in nice aroma of the brown rice, and also allows reduction of a rice bran smell. The heat-moisture treatment can be performed using commercially available heat-moisture treatment device, and specific examples of the heat-moisture treatment device include an autoclave and rapid preparation sterilization equipment.

The brown rice after the heat-moisture treatment is further subjected to heat-treatment. The brown rice after the heat-moisture treatment may be directly subjected to heat treatment without being cooled, or may be subjected to heat treatment after the brown rice is cooled to intended temperature.

Heating temperature of the heat treatment is from 80 to 100° C., preferably from 85 to 100° C., and more preferably from 90 to 100° C.

Time for the heat treatment is within the range of from 5 to 90 minutes. As the temperature is higher, the treatment is ordinarily completed in a shorter treatment time. For example, when the temperature is from about 90° C. to about 100° C., the treatment time is allowed to be from 5 to 60 minutes, preferably from 10 to 60 minutes, more preferably from 15 to 45 minutes, and more preferably from 20 to 40 minutes. Temperature may be constant during the heat treatment, or may be varied. Water content of the brown rice immediately after the heat treatment is preferably from 25 to 60% by mass, more preferably from 30 to 55% by mass, more preferably from 30 to 50% by mass, and more preferably from 35 to 50% by mass.

The method of the heat treatment is not particularly limited, and a method of performing the heat treatment under moistness is preferable. The moistness condition is preferably from 80 to 100% relative humidity (hereinafter, referred to as RH), more preferably from 90 to 100% RH, and more preferably saturated vapor.

As the method for performing the heat treatment under moistness, a method selected from a method of putting brown rice into an open container soaked in warm water, a method of soaking brown rice in warm water, and a method of performing heat-moisture treatment using water vapor is preferably applied, and application of the method of performing heat-moisture treatment using water vapor is more preferred.

The brown rice subjected to heat-moisture treatment and heat treatment after the heat-moisture treatment can be directly eaten, but is preferably subsequently subjected to drying treatment so as to be suitable condition for eating after boiling in a manner similar to ordinary brown rice. The drying treatment is a treatment for reducing water content in the brown rice. From a viewpoint of storage stability of processed brown rice to be produced, the water content in the brown rice is adjusted by the drying treatment to be 15% by mass or less, and more preferably from 5 to 15% by mass. Moreover, water activity of the brown rice is adjusted by the drying treatment to be preferably 0.6 or less, and more preferably from 0.2 to 0.6. The water activity can be measured using a water activity measurement instrument (trade name: IC-500, manufactured by Novasina AG). A drying method is not particularly limited, and the drying treatment is preferably performed under conditions of a temperature of from 40 to 60° C., and preferably from 45 to 55° C.; and a humidity of from 30 to 70% RH, and preferably from 50 to 60% RH. Under these conditions, the drying treatment is preferably performed for from 1 to 5 hours, and preferably from: 2 to 3 hours.

Raw brown rice is subjected to the above-mentioned production steps, thereby allowing an increase in the content of cycloartenol in the brown rice. Accordingly, the content of cycloartenol in the processed brown rice produced by the production method of the present invention is higher than the content of cycloartenol in raw brown rice used as a raw material, when compared based on 100 g of dried form. With regard to the processed brown rice produced by the above-mentioned production method, the mass of cycloartenol contained in 100 g of dried form of the processed brown rice is preferably 1.4 times or more, more preferably 1.5 times or more, and more preferably 1.6 times or more the mass of cycloartenol contained in 100 g of dried form of the raw brown rice used as the raw material (raw brown rice before processing). Here, according to the present invention, “dried form” of raw brown rice or processed brown rice means one obtained by freezing the raw brown rice or the processed brown rice with liquid nitrogen, and then performing freeze drying (−80° C., 5 Pa, 48 hours). The mass of cycloartenol contained in 100 g of dried form of the processed brown rice is ordinarily 3.5 times or less, and may be 3 times or less, may be 2 times or less, and may be 1.8 times or less the mass of cycloartenol contained in 100 g of dried form of the raw brown rice before processing.

The content of cycloartenol per 100 g of dried form of the processed brown rice produced by the above-mentioned production method is preferably 6.4 mg or more, more preferably 6.7 mg or more, and more preferably 7.0 mg or more. Moreover, an upper limit of the content of cycloartenol in the processed brown rice produced by the above-mentioned production method is not particularly limited, and is ordinarily 16 mg or less, and may be 14 mg or less, may be 11 mg or less, may be 9 mg or less, and may be 8 mg or less per 100 g of dried form of the processed brown rice.

Moreover, raw brown rice is subjected to operations in each of the above-mentioned production steps, thereby allowing an increase in the content of 24-methylenecycloartanol in the brown rice. Accordingly, the content of 24-methylenecycloartanol in the processed brown rice produced by the production method of the present invention is higher than the content of 24-methylenecycloartanol in raw brown rice used as a raw material, when compared based on 100 g of dried form. In the processed brown rice produced by the above-mentioned production method, the mass of 24-methylenecycloartanol contained in 100 g of dried form of the processed brown rice is preferably 1.5 times or more, more preferably 1.6 times or more the mass of 24-methylenecycloartanol contained in 100 g of dried form of the raw brown rice before processing. The mass of 24-methylenecycloartanol contained in 100 g of dried form of the processed brown rice is ordinarily 3 times or and may be 2 times or less, and may be 1.9 times or less the mass of 24-methylenecycloartanol contained in 100 g of dried form of the raw brown rice before processing.

The content of 24-methylenecycloartanol per 100 g of dried form of the processed brown rice produced by the above-mentioned production method is preferably 4.5 mg or more, and more preferably 4.8 mg or more. Moreover, an upper limit of the content of 24-methylenecycloartanol in the processed brown rice produced by the above-mentioned production method is not particularly limited, and is ordinarily 14 mg or less, and may be 10 mg or less, may be 7 mg or less, and may be 6 mg or less per 100 g of dried form of the processed brown rice.

Moreover, raw brown rice is subjected to operations in each of the above-mentioned production steps, thereby allowing an increase in the total content of cycloartenol and 24-methylenecycloartanol in the brown rice. Accordingly, the total content of cycloartenol and 24-methylenecycloartanol in the processed brown rice produced by the production method of the present invention is higher than the total content of cycloartenol and 24-methylenecycloartanol in raw brown rice used as a raw material, when compared based on 100 g of dried form. In the processed brown rice produced by the above-mentioned production method, the total mass of cycloartenol and 24-methylenecycloartanol contained in 100 g of dried form of the processed brown rice is preferably 1.4 times or more, more preferably 1.5 times or more, and more preferably 1.6 times or more the total mass of cycloartenol and 24-methylenecycloartanol contained in 100 g of dried form of the raw brown rice before processing. The total mass of cycloartenol and 24-methylenecycloartanol contained in 100 g of dried form of the processed brown rice is ordinarily 4.5 times or less, and may be 3 times or less, may be 2 times or less, and may be 1.8 times or less the total mass of cycloartenol and 24-methylenecycloartanol contained in 100 g of dried form of the raw brown rice before processing.

The total content of cycloartenol and 24-methylenecycloartanol per 100 g of dried form of the processed brown rice produced by the above-mentioned production method is preferably 11 mg or more, and more preferably 12 mg or more. Moreover, an upper limit of the total content of cycloartenol and 24-methylenecycloartanol in the processed brown rice produced by the above-mentioned production method is not particularly limited, and is ordinarily 30 mg or less, and may be 20 mg or less, may be 16 mg or less, and may be 14 mg or less per 100 g of dried form of the processed brown rice.

Cycloartenol and 24-methylenecycloartanol are compounds represented by the following Formulae (1) and (2), respectively, and both of them are a plant sterol belonging to 4,4-dimethylsterols.

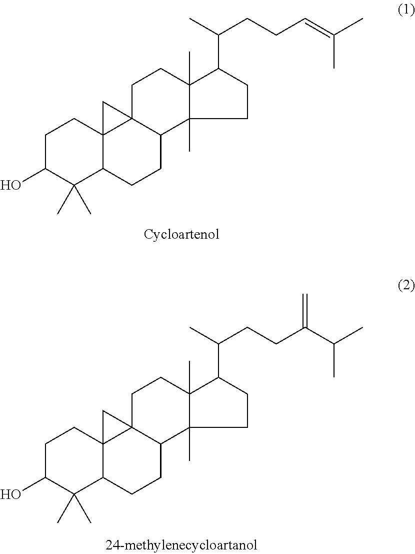 [SMILES: CC(C)=CCCC(C)C1CCC2(C)C3CCC4C(C)(C)C(O)CCC45CC35CCC12C ; C=C(CCC(C)C1CCC2(C)C3CCC4C(C)(C)C(O)CCC45CC35CCC12C)C(C)C]

Cycloartenol and 24-methylenecycloartanol are known to exist mainly in rice bran. In the raw brown rice, a large part of cycloartenol and 24-methylenecycloartanol exists in a form of a ferulic acid ester being ester-bonded with ferulic acid, or a fatty acid ester being ester-bonded with fatty acid, and a ratio present as a free form is small. On the other hand, a form having a physiological effect, including an effect of preventing and improving lifestyle-related diseases, is mainly the free form, and the above-described ester is known to be poorer in physiological activity in comparison with the free form. In the present invention, both of cycloartenol and 24-methylenecycloartanol mean the free form, and do not encompass bound forms such as the ester form.

An increase of free cycloartenol and 24-methylenecycloartanol in the brown rice is considered to be allowed when the ester bond of the above-described ester is cleaved, but cleavage of the ester bond of the above-described cycloartenol ester and 24-methylenecycloartanol ester are known to be hard ordinarily by heating at from about 100° C. to about 200° C.

According to the production method of the present invention, heating temperature of from 110 to 150° C. is applied in the heat-moisture treatment, and with regard to applying the heat treatment, the temperature is only from 80 to 100° C. Under heating conditions of this level, cleavage of the ester bond of the cycloartenol ester or 24-methylenecycloartanol ester present in the brown rice is considered to be hard. However, surprisingly, the content of cycloartenol or 24-methylenecycloartanol in the brown rice significantly increases according to the production method of the present invention. As the reason therefor, a component specific to the brown rice is considered to accelerate thermal cleavage of the ester bond of the cycloartenol ester or 24-methylenecycloartanol ester.

The content of cycloartenol and 24-methylenecycloartanol in the processed brown rice produced by the production method of the present invention can be measured by the after-mentioned procedure described in Examples.

The production method of the present invention allows to obtain the processed brown rice containing increased amount of cycloartenol or 24-methylenecycloartanol in comparison with raw brown rice, by using the raw brown rice as a raw material.

Moreover, with regard to the processed brown rice according to the present invention, the content of cycloartenol or 24-methylenecycloartanol is increased in comparison with raw brown rice before processing.

The production method of the present invention can be utilized for producing processed brown rice containing increased amount of cycloartenol or 24-methylenecycloartanol by using raw brown rice as a raw material, and the processed brown rice is suitable for boiling and consumption.

The processed brown rice produced by the production method of the present invention can be suitably used as a foodstuff useful for preventing and improving the lifestyle-related diseases.

With regard to the above-mentioned embodiment, the present invention discloses the following production method of processed brown rice, and processed brown rice.

<1>

A method of producing processed brown rice, comprising at least the steps of:

subjecting raw brown rice to heat-moisture treatment using water vapor having a temperature of from 110 to 150° C. for from 5 to 90 minutes; and

subjecting the brown rice after the heat-moisture treatment to heat treatment at a temperature of from 80 to 100° C. for from 5 to 90 minutes.

<2>

The production method according to the above item <1>, wherein the raw brown rice is one kind or two or more kinds selected from non-waxy rice and waxy rice, and preferably one kind or two or more kinds of non-waxy rice.

<3>

The production method according to the above item <1> or <2>, wherein the raw brown rice is one kind or two or more kinds selected from Japonica rice, Indica rice, and a hybrid of the Japonica rice and the Indica rice, and preferably one kind or two or more kinds of Japonica rice.

<4>

The production method according to any one of the above items <1> to <3>, wherein the raw brown rice is one kind or two or more kinds of cultivars selected from Koshihikari, Hinohikari, Milky Queen, Sari Queen, Hitomebore, Akitakomachi and Yumetoiro.

<5>

The production method according to any one of the above items <1> to <4>, wherein, in the heat-moisture treatment, the temperature of the water vapor is from 110 to 145° C., preferably from 115 to 140° C., more preferably from 120 to 135° C., and more preferably from 125 to 135° C.

<6>

The production method according to any one of the above items <1> to <5>, wherein the time for the heat-moisture treatment is from 20 to 90 minutes, preferably from 30 to 70 minutes, and more preferably from 40 to 60 minutes.

<7>

The production method according to any one of the above items <1> to <6>, wherein the heat-moisture treatment is performed under saturated vapor pressure.

<8>

The production method according to any one of the above items <1> to <7>, wherein the heat-moisture treatment is performed so that water content of the brown rice immediately after the heat-moisture treatment is from 20 to 70% by mass, preferably from 25 to 50% by mass, and more preferably from 30 to 45% by mass.

<9>

The production method according to any one of the above items <1> to <8>, wherein the temperature of the heat treatment is from 85 to 100° C., and preferably from 90 to 100° C.

<10>

The production method according to any one of the above items <1> to <9>, wherein the time for the heat treatment is from 5 to 60 minutes, preferably from 10 to 60 minutes, more preferably from 15 to 45 minutes and more preferably from 20 to 40 minutes.

<11>

The production method according to any one of the above items <1> to <10>, wherein the heat treatment is performed under the condition of a humidity of from 80 to 100% RH, preferably from 90 to 100% RH, and is more preferably performed with saturated vapor.

<12>

The production method according to any one of the above items <1> to <11>, wherein the heat treatment is heat-moisture treatment using water vapor.

<13>

The production method according to any one of the above items <1> to <12>, wherein the treatments are performed so that water content of the brown rice immediately after the heat treatment is from 25 to 60% by mass, preferably from 30 to 55% by mass, more preferably from 30 to 50% by mass, and more preferably from 35 to 50% by mass.

<14>

The production method according to any one of the above items <1> to <13>, comprising subjecting brown rice after the heat treatment to drying treatment.

<15>

The production method according to the above item <14>, wherein the drying treatment is performed under the condition of a temperature of from 40 to 60° C., and preferably from 45 to 55° C.

<16>

The production method according to the above item <14> or <15>, wherein the drying treatment is performed under the condition of a humidity of from 30 to 70% RH, and preferably from 50 to 60% RH.

<17>

The production method according to any one of the above items <14> to <16>, wherein the time for the drying treatment is from 1 to 5 hours, and preferably from 2 to 3 hours,

<18>

The production method according to any one of the above items <14> to <17>, wherein water content of the processed brown rice produced is 15% by mass or less, and preferably from 5 to 15% by mass.

<19>

The production method according to any one of the above items <14> to <18>, wherein water activity of the processed brown rice produced is 0.6 or less, and preferably from 0.2 to 0.6.

<20>

The production method according to any one of the above items <1> to <19>, wherein the mass of cycloartenol contained in 100 g of dried form of the processed brown rice is 1.4 times or more, preferably 1.5 times or more, and more preferably 1.6 times or more the mass of cycloartenol contained in 100 g of dried form of the raw brown rice before processing.

<21>

The production method according to in any one of the above items <1> to <20>, wherein the mass of cycloartenol contained in 100 g of dried form of the processed brown rice is 3.5 times or less, and may be 3 times or less, may be 2 times or less, and may be 1.8 times or less the mass of cycloartenol contained in 100 g of dried form of the raw brown rice before processing.

<22>

The production method according to any one of the above items <1> to <21>, wherein the mass of 24-methylenecycloartanol contained in 100 g of dried form of the processed brown rice is 1.5 times or more, preferably 1.6 times or more the mass of 24-methylenecycloartanol contained in 100 g of dried form of the raw brown rice before processing.

<23>

The production method according to any one of the above items <1> to <22>, wherein the mass of 24-methylenecycloartanol contained in 100 g of dried form of the processed brown rice is 3 times or less, and may be 2 times or less, and may be 1.9 times or less the mass of 24-methylenecycloartanol contained in 100 g of dried form of the raw brown rice before processing.

<24>

The production method according to any one of the above items <1> to <23>, wherein the total mass of cycloartenol and 24-methylenecycloartanol contained in 100 g of dried form of the processed brown rice is 1.4 times or more, preferably 1.5 times or more, and more preferably 1.6 times or more the total mass of cycloartenol and 24-methylenecycloartanol contained in 100 g of dried form of the raw brown rice before processing.

<25>

The production method according to any one of the above items <1> to <24>, wherein the total mass of cycloartenol and 24-methylenecycloartanol contained in 100 g of dried form of the processed brown rice is preferably 4.5 times or less, and may be 3 times or less, may be 2 times or less, and may be 1.8 times or less the total mass of cycloartenol and 24-methylenecycloartanol contained in 100 g of dried form of the raw brown rice before processing.

<26>

Processed brown rice comprising cycloartenol in an amount of 6.4 mg or more, preferably 6.7 mg or more, and more preferably 7.0 mg or more per 100 g of dried form of the processed brown rice.

<27>

The processed brown rice according to the above item <26>, wherein the content of cycloartenol per 100 g of the dried form of the processed brown rice is 16 mg or less, and may be 14 mg or less, may be 11 mg or less, may be 9 mg or less, and may be 8 mg or less.

<28>

Processed brown rice comprising 24-methylenecycloartanol in an amount of 4.5 mg or more, preferably 4.8 mg or more per 100 g of dried form of the processed brown rice.

<29>

The processed brown rice according to the above item <28>, wherein the content of 24-methylenecycloartanol per 100 g of the dried form of the processed brown rice is 14 mg or less, and may be 10 mg or less, may be 7 mg or less, and may be 6 mg or less.

<30>

Processed brown rice comprising cycloartenol and 24-methylenecycloartanol in an amount of 11.0 mg or more, and preferably 12 mg or more in total per 100 g of dried form of the processed brown rice.

<31>

The processed brown rice according to the above item <30>, wherein the total content of cycloartenol and 24-methylenecycloartanol per 100 g of the dried form of the processed brown rice is 30 mg or less, and may be 20 mg or less, may be 16 mg or less, and may be 14 mg or less.

<32>

The processed brown rice according to the above item <26> or <27>, comprising 24-methylenecycloartanol in an amount of 4.5 mg or more, and preferably 4.8 mg or more per 100 g of the dried form.

<33>

The processed brown rice according to the above item <32>, wherein the content of 24-methylenecycloartanol per 100 g of the dried form of the processed brown rice is 14 mg or less, and may be 10 mg or less, may be 7 mg or less, and may be 6 mg or less.

<34>

The processed brown rice according to the above items <26> to <29> and <31> to <33>, comprising cycloartenol and 24-methylenecycloartanol in an amount of 11.0 mg or more, and preferably 12 mg or more in total per 100 g of the dried form.

<35>

The processed brown rice according to the above item <34>, wherein the total content of cycloartenol and 24-methylenecycloartanol per 100 g of the dried form of the processed brown rice is 30 mg or less, and may be 20 mg or less, may be 16 mg or less, and may be 14 mg or less.

<36>

The processed brown rice according to any one of the above items <26> to <35>, wherein the processed brown rice is one kind or two or more kinds selected from non-waxy rice and waxy rice, and preferably one kind or two or more kinds of non-waxy rice.

<37>

The processed brown rice according to any one of the above items <26> or <36>, wherein the processed brown rice is one kind or two or more kinds selected from Japonica rice, Indica rice, and a hybrid of the Japonica rice and the Indica rice, and preferably one kind or two or more kinds of Japonica rice.

<38>

The processed brown rice according to any one of the above items <26> to <37>, wherein the processed brown rice is a cultivar selected from Koshihikari, Hinohikari, Milky Queen, Sari Queen, Hitomebore, Akitakomachi and Yumetoiro.

<39>

The processed brown rice according to any one of the above items <26> to <38>, wherein water content of the processed brown rice is 15% by mass or less, and preferably from 5 to 15% by mass.

<40>

The production method according to any one of the above items <26> to <39>, wherein water activity of the processed brown rice is 0.6 or less, and preferably from 0.2 to 0.6.

### EXAMPLES

Hereinafter, the present invention will be described more in detail with reference to Examples, but the present invention is not limited thereto.

### [Analytical Method]

### Measurement of Cycloartenol and 24-Methylenecycloartanol in Brown Rice:

Cycloartenol and 24-methylenecycloartanol were extracted by repeating three times an extraction operation of 100 g of freeze-dried brown rice ground material (frozen with liquid nitrogen and then freeze dried at −80° C., 5 Pa for 48 hours, and ground) using 300 g of solvent composed of chloroform/methanol=3/1. The solvent was distilled off by a rotary evaporator, and then the resultant material was dissolved into hexane again, and an insoluble component was removed by centrifugal separation. Then, the solvent was distilled off, 500 mg of extracted oil was dissolved in 5 mL of hexane, and subjected to solid phase treatment (Sep-Pak Silica), and the resultant material was washed with a solvent composed of hexane/ether=95/5, and then eluted with a solvent composed of ethanol/ether/hexane=50/25/25. Then, the resultant material was subjected to HPTLC (Merk#1.13895 SiI60), and developed with a solvent composed of hexane/ether/acetic acid=90/10/2, and a solvent composed of chloroform/ether=95/5 to scrape a free sterol part, and a free sterol was eluted from a scraped carrier using a solvent composed of ethanol/ether/hexane=50/25/25. An effluent obtained was saponified and decomposed with alkali, and cycloartenol and 24-methylenecycloartanol were quantitatively determined by gas chromatography using cholesterol as an internal standard material.

### Example 1

### Production of Processed Brown Rice According to Production Method of the Present Invention-1

Then, 150 g of commercially available raw brown rice (Hinohikari, produced in the 2009 fiscal year) was used as a raw material, washed with water, and then drained off using a sieve, and soaked in chilled water at 5° C. for 12 hours. Brown rice removed from chilled water was subjected to heat-moisture treatment using water vapor having a temperature of 125° C. for 60 minutes, using rapid preparation sterilization equipment (manufactured by Hisaka Works Co., Ltd.). Then, an open container containing brown rice after the heat-moisture treatment was installed in an upper part of water in a container in which the water was boiled, whereby, heat treatment was conducted with water vapor having a temperature of 100° C. for 30 minutes.

Brown rice after the heat treatment was dried at 50° C. for 3 hours using Hi-Coater Labo (manufactured by Freund Industrial Co., Ltd.), and thus processed brown rice was obtained (hereinafter, referred to as Present Invention Product 1)

### Example 2

### Production of Processed Brown Rice According to Production Method of the Present Invention-2

Then, 150 g of commercially available raw brown rice (Hinohikari, produced in the 2009 fiscal year) was used as a raw material, washed with water, and then drained off using a sieve, and soaked in chilled water at 5° C. for 12 hours. Brown rice removed from chilled water was subjected to heat-moisture treatment using water vapor having a temperature of 135° C. for 60 minutes, using rapid preparation sterilization equipment (manufactured by Hisaka Works Co., Ltd.). Then, an open container containing brown rice after the heat-moisture treatment was installed in an upper part of water in a container in which the water was boiled, whereby, heat treatment was conducted with water vapor having a temperature of 100° C. for 30 minutes.

Brown rice after the heat treatment was dried at 50° C. for 3 hours using Hi-Coater Labo (manufactured by Freund Industrial Co., Ltd.), and thus processed brown rice was obtained (hereinafter, referred to as Present Invention Product 2).

### Example 3

### Production of Processed Brown Rice According to Production Method of the Present Invention-3

Then, 150 g of commercially available raw brown rice (Hinohikari, produced in the 2009 fiscal year) was used as a raw material, washed with water, and then drained off using a sieve, and soaked in chilled water at 5° C. for 12 hours. Brown rice removed from chilled water was subjected to heat-moisture treatment using water vapor having a temperature of 145° C. for 40 minutes, using rapid preparation sterilization equipment (manufactured by Hisaka Works Co., Ltd.). Then, an open container containing brown rice after the heat-moisture treatment was installed in an upper part of water in a container in which the water was boiled, whereby, heat treatment was conducted with water vapor having a temperature of 100° C. for 30 minutes.

Brown rice after the heat treatment was dried at 50° C. for 3 hours using Hi-Coater Labo (manufactured by Freund Industrial Co, Ltd.), and thus processed brown rice was obtained (hereinafter, referred to as Present Invention Product 3).

### Example 4

### Production of Processed Brown Rice According to Production Method of the Present Invention-4

Then, 150 g of commercially available raw brown rice (Hinohikari, produced in the 2010 fiscal year) was used as a raw material, washed with water, and then drained off using a sieve, and soaked in chilled water at 5° C. for 12 hours. Brown rice removed from chilled water was subjected to heat-moisture treatment using water vapor having a temperature of 135° C. for 60 minutes, using rapid preparation sterilization equipment (manufactured by Hisaka Works Co., Ltd.). Water content immediately after the heat-moisture treatment was 37.3% by mass. Then, an open container containing brown rice after the heat-moisture treatment was installed in an upper part of water in a container containing warm water at 85° C., whereby, heat treatment was conducted with water vapor having a temperature of 85° C. for 30 minutes. Water content immediately after the heat treatment was 34.9% by mass.

Brown rice after the heat treatment was dried at 50° C. for 3 hours using Hi-Coater Labo (manufactured by Freund Industrial Co., Ltd.), and thus processed brown rice was obtained (hereinafter, referred to as Present Invention Product 4). Water content of the processed brown rice was 11.2% by mass.

### Example 5

### Production of Processed Brown Rice According to Production Method of the Present Invention-5

Then, 150 g of commercially available raw brown rice (Hinohikari, produced in the 2010 fiscal year) was used as a raw material, washed with water, and then drained off using a sieve, and soaked in chilled water at 5° C. for 12 hours. Brown rice removed from chilled water was subjected to heat-moisture treatment using water vapor having a temperature of 135° C. for 60 minutes, using rapid preparation sterilization equipment (manufactured by Hisaka Works Co., Ltd.). Water content immediately after the heat-moisture treatment was 35.2% by mass. Then, an open container containing brown rice after the heat-moisture treatment was installed in an upper part of water in a container containing warm water at 85° C., whereby, heat treatment was conducted with water vapor having a temperature of 85° C. for 60 minutes. Water content immediately after the heat treatment was 33.0% by mass.

Brown rice after the heat treatment was dried at 50° C. for 3 hours using Hi-Coater Labo (manufactured by Freund Industrial Co., Ltd.), and thus processed brown rice was obtained (hereinafter, referred to as Present Invention Product 5). Water content of the processed brown rice was 10.9% by mass.

### Example 6

### Production of Processed Brown Rice According to Production Method of the Present Invention-6

Then, 150 g of commercially available raw brown rice (Hinohikari, produced in the 2010 fiscal year) was used as a raw material, washed with water, and then drained off using a sieve, and soaked in chilled water at 5° C. for 12 hours. Brown rice removed from chilled water was subjected to heat-moisture treatment using water vapor having a temperature of 135° C. for 60 minutes, using rapid preparation sterilization equipment (manufactured by Hisaka Works Co., Ltd.). Water content immediately after the heat-moisture treatment was 36.0% by mass. Then, an open container containing brown rice after the heat-moisture treatment was installed in an upper part of water in a container in which water was boiled, whereby, heat treatment was conducted with water vapor having a temperature of 100° C. for 6 minutes. The water content immediately after the heat treatment was 35.0% by mass.

Brown rice after the heat treatment was dried at 50° C. for 3 hours using Hi-Coater Labo (manufactured by Freund Industrial Co., Ltd.), and thus processed brown rice was obtained (hereinafter, referred to as Present invention Product 6). The water content of the processed brown rice was 11.5% by mass.

### Example 7

### Production of Processed Brown Rice According to Production Method of the Present Invention-7

Then, 150 g of commercially available raw brown rice (Hinohikari, produced in the 2010 fiscal year) was used as a raw material, washed with water, and then drained off using a sieve, and soaked in chilled water at 5° C. for 12 hours. Brown rice removed from chilled water was subjected to heat-moisture treatment using water vapor having a temperature of 135° C. for 60 minutes, using rapid preparation sterilization equipment (manufactured by Hisaka Works Co., Ltd.). The water content immediately after the heat-moisture treatment was 36.7% by mass. Then, an open container containing brown rice after the heat-moisture treatment was installed in an upper part of water in a container in which water was boiled, whereby, heat treatment was conducted with water vapor having a temperature of 100° C. for 15 minutes. The water content immediately after the heat treatment was 34.5% by mass.

Brown rice after the heat treatment was dried at 50° C. for 3 hours using Hi-Coater Labo (manufactured by Freund industrial Co., Ltd.), and thus processed brown rice was obtained (hereinafter, referred to as Present Invention Product 7). The water content of processed brown rice was 11.7% by mass.

### Comparative Example

### Production of Processed Brown Rice not According to the Production Method of the Present Invention

Then, 150 g of commercially available raw brown rice (Hinohikari, produced in the 2009 fiscal year) was used as a raw material, washed with water, and then drained off using a sieve, and soaked in chilled water at 5° C. for 12 hours. Brown rice removed from chilled water was subjected to heat-moisture treatment using water vapor having a temperature of 125° C. for 60 minutes, using rapid preparation sterilization equipment (manufactured by Hisaka Works Co., Ltd.).

Brown rice after the heat-moisture treatment was dried at 50° C. for 3 hours using Hi-Coater Labo (manufactured by Freund Industrial Co., Ltd.), and thus processed brown rice was obtained (hereinafter, referred to as Comparative Product 1).

Then, 150 g of commercially available raw brown rice (Hinohikari, produced in the 2009 fiscal year) was used as a raw material, washed with water, and then drained off using a sieve, and soaked in chilled water at 5° C. for 12 hours. An open container containing brown rice after soaked in chilled water was installed in an upper part of water in a container in which water was boiled, whereby, heat treatment was conducted with water vapor having a temperature of 100° C. for 30 minutes.

Brown rice after the heat treatment was dried at 50° C. for 3 hours using Hi-Coater Labo (manufactured by Freund Industrial Co., Ltd.), and thus processed brown rice was obtained (hereinafter, referred to as Comparative Product 2).

Further, raw brown rice per se being a raw material was made Comparative Product 3.

### Test Example 1

### Measurement of Cycloartenol and 24-Methylenecycloartanol

With regard to the Present Invention Products 1 to 7 and Comparative Products 1 to 3 described above, dried forms thereof were prepared and the content (mg) of cycloartenol and the content (mg) of 24-methylenecycloartanol per 100 g of each dried form were measured, respectively.

Moreover, the content (mg) of cycloartenol, the content (mg) of 24 methylenecycloartanol, and a total content (mg) of both per 100 g of each dried form were divided by the content (mg) of cycloartenol, the content (mg) of 24-methylenecycloartanol, and a total content (mg) of both per 100 g of dried form of the Comparative Product 3, respectively, thereby calculating increasing ratio of each component in comparison with raw brown rice before processing.

The results are shown in the following Table 1.

TABLE 1

| | Present Invention Product | | | | | | | Comparative Product | | |
|---|---|---|---|---|---|---|---|---|---|---|
| | 1 | 2 | 3 | 4 | 5 | 6 | 7 | 1 | 2 | 3 |
| Heat-moisture treatment | 125° C. | 135° C. | 145° C. | 135° C. | 135° C. | 135° C. | 135° C. | 125° C. | — | Untreated |
| | 60 min | 60 min | 40 min | 60 min | 60 min | 60 min | 60 min | 60 min | | |
| Heat treatment | 100° C. | 100° C. | 100° C. | 85° C. | 85° C. | 100° C. | 100° C. | — | 100° C. | |
| | 30 min | 30 min | 30 min | 30 min | 60 min | 6 min | 15 min | | 30 min | |
| Cycloartenol | 7.0 | 7.4 | 6.7 | 6.8 | 6.5 | 7.2 | 7.3 | 5.9 | 4.7 | 4.7 |
| Increasing ratio from raw | 1.5 | 1.6 | 1.4 | 1.5 | 1.4 | 1.5 | 1.6 | 1.3 | 1.0 | 1.0 |
| brown rice | | | | | | | | | | |
| 24-methylenecycloartanol | 4.5 | 5.0 | 4.6 | 5.3 | 5.2 | 5.4 | 5.5 | 3.9 | 3.0 | 3.0 |
| Increasing ratio from raw | 1.5 | 1.6 | 1.5 | 1.8 | 1.7 | 1.8 | 1.8 | 1.3 | 1.0 | 1.0 |
| brown rice | | | | | | | | | | |
| Total of cycloartenol and | 11.5 | 12.4 | 11.3 | 12.1 | 11.7 | 12.6 | 12.8 | 9.8 | 7.7 | 7.7 |
| 24-methylenecycloartanol | | | | | | | | | | |
| Increasing ratio from raw | 1.5 | 1.6 | 1.5 | 1.6 | 1.5 | 1.6 | 1.7 | 1.3 | 1.0 | 1.0 |
| brown rice | | | | | | | | | | |

From the results in Table 1, while both the content of cycloartenol and the content of 24-methylenecycloartanol per 100 g of dried form increased in Comparative Product 1 in which only the heat-moisture treatment at 125° C. for 60 minutes was applied, in comparison with Comparative Product 3 being raw brown rice, the content did not reach the level of the Present Inventions. Neither the content of cycloartenol nor the content of 24-methylenecycloartanol per 100 g of dried form increased in Comparative Product 2 in which only the heat treatment at 100° C. for 30 minutes was applied, in comparison with Comparative Product 3 being raw brown rice.

In contrast, in Present Invention Products 1 to 7 produced according to the production method of the present invention, the content of cycloartenol per 100 g of dried form increased 1.4 times or more, and the content of 24-methylenecycloartanol increased 1.5 times or more, and the total content of cycloartenol and 24-methylenecycloartanol also increased 1.5 times or more, in comparison with Comparative Product 3 being the raw brown rice.

These results show that, according to the production method of the present invention, processed brown rice containing increased amount of cycloartenol or 24-methylenecycloartanol in comparison with raw brown rice can be produced using the raw brown rice as a raw material.

### Test Example 2

### Evaluation of Flavor and Food Texture of Boiled Rice

Present Invention Products 1 to 3 and Comparative Products 1 to 7 were put into water in an amount of 1.5 times by mass based on dried form mass thereof and soaked in the water at room temperature for 1 hour, and boiled under a white rice mode (a polished rice mode) of a rice cooker (trade name: JKH-A, manufactured by Tiger Corporation). With regard to the thus obtained boiled rice, flavor and food texture thereof were evaluated by six special panels, and an evaluation value thereof was determined through consultation based on the following evaluation criteria. Ordinary boiled brown rice means general boiled brown rice obtained by boiling brown rice under a brown rice mode of a rice cooker.

### [Flavor]

4: With almost no sense of rice bran smell sensed for ordinary boiled brown rice, and still further increased nice aroma.
3: With further suppressed rice bran smell and increased nice aroma in comparison with ordinary boiled brown rice.
2: With rice bran smell and nice aroma in a manner similar to ordinary boiled brown rice.
1: With inferior rice bran smell and nice aroma in comparison with ordinary boiled brown rice.

### [Food Texture]

4: With higher softness and elasticity in comparison with ordinary boiled brown rice.
3: With relatively higher softness and elasticity in comparison with ordinary boiled brown rice.
2: With hardness and elasticity in a similar manner to ordinary boiled brown rice.
1: With higher hardness to sense a hard core in comparison with ordinary boiled brown rice.

The results are shown in Table 2.

TABLE 2

| | Present Invention | | | | | | | Comparative | | |
|---|---|---|---|---|---|---|---|---|---|---|
| | Product | | | | | | | Product | | |
| | 1 | 2 | 3 | 4 | 5 | 6 | 7 | 1 | 2 | 3 |
| Flavor | 4 | 4 | 4 | 3 | 3 | 2 | 3 | 3 | 2 | 1 |
| Food texture | 4 | 4 | 3 | 3 | 3 | 2 | 3 | 4 | 2 | 1 |

Comparative Product 3 being untreated raw brown rice resulted, when the rice was boiled under a white rice mode, in boiled rice with poorer flavor and poorer elasticity in comparison with ordinary boiled brown rice.

Boiled rice obtaining by boiling Present Invention Products 1 to 7 produced by the production method of the present invention under a white rice mode had almost no rice bran smell sensed for ordinary boiled brown rice, and significantly increased nice aroma. Moreover, they were cooked into softer rice in comparison with ordinary boiled brown rice, and had moderate elasticity.

The results in the above-described Test Examples 1 and 2 show that the production method of the present invention was found to allow an increase in the content of cycloartenol and the content of 24-methylenecycloartanol in the brown rice, and the processed brown rice produced by the production method of the present invention was found, even when the rice was boiled under a white rice mode of the rice cooker, to be cooked into boiled rice with both excellent flavor and excellent food texture.

Having described our invention as related to the present embodiments, it is our intention that the invention not be limited by any of the details of the description, unless otherwise specified, but rather be construed broadly within its spirit and scope as set out in the accompanying claims.

This application claims priority on Patent Application No. 2011-165987 filed in Japan on Jul. 28, 2011, which is entirely herein incorporated by reference.

What is claimed is:

1. A method of producing processed brown rice, comprising at least the steps of:
washing raw brown rice, and then subjecting the raw brown rice to heat-moisture treatment using water vapor having a temperature of from 110 to 150° C. for from 5 to 90 minutes; and
subjecting the brown rice after the heat-moisture treatment to heat treatment at a temperature of from 80 to 100° C. for from 5 to 90 minutes.

2. The method of producing processed brown rice according to claim 1, wherein the mass of cycloartenol contained in 100 g of dried form of the processed brown rice is 1.4 times or more the mass of cycloartenol contained in 100 g of dried form of the raw brown rice before processing.

3. The method of producing processed brown rice according to claim 1, wherein the mass of 24-methylenecycloartanol contained in 100 g of dried form of the processed brown rice is 1.5 times or more the mass of 24-methylenecycloartanol contained in 100 g of dried form of the raw brown rice before processing.

4. The method of producing processed brown rice according to claim 1, wherein the total mass of cycloartenol and 24-methylenecycloartanol contained in 100 g of dried form of the processed brown rice is 1.4 times or more the total mass of cycloartenol and 24-methylenecycloartanol contained in 100 g of dried form of the raw brown rice before processing.

5. The method of producing processed brown rice according to claim 1, comprising subjecting the brown rice after the heat treatment to a drying treatment.

6. Processed brown rice comprising cycloartenol in an amount of 6.4 mg or more per 100 g of dried form of the processed brown rice.

7. Processed brown rice comprising 24-methylenecycloartanol in an amount of 4.5 mg or more per 100 g of dried form of the processed brown rice.

8. Processed brown rice comprising cycloartenol and 24-methylenecycloartanol in an amount of 11.0 mg or more in total per 100 g of dried form of the processed brown rice.

9. The method of producing processed brown rice according to claim 1, wherein the time for the heat-moisture treatment is from 20 to 90 minutes.

10. The method of producing processed brown rice according to claim 1, wherein the heat-moisture treatment is performed so that water content of the brown rice immediately after the heat-moisture treatment is from 20 to 70% by mass.

11. The method of producing processed brown rice according to claim 1, wherein the time for the heat treatment is from 5 to 60 minutes.

12. The method of producing processed brown rice according to claim 1, wherein the treatments are performed so that water content of the brown rice immediately after the heat treatment is from 25 to 60% by mass.

13. The method of producing processed brown rice according to claim 5, wherein the drying treatment is performed under the condition of a humidity of from 30 to 70% RH.

14. The method of producing processed brown rice according to claim 1, wherein water activity of the processed brown rice produced is 0.6 or less.

15. The processed brown rice according to claim 6, wherein the content of cycloartenol per 100 g of the dried form of the processed brown rice is 16 mg or less.

16. The processed brown rice according to claim 7, wherein the content of 24-methylenecycloartanol per 100 g of the dried form of the processed brown rice is 14 mg or less.

17. The processed brown rice according to claim 8, wherein the total content of cycloartenol and 24-methylenecycloartanol per 100 g of the dried form of the processed brown rice is 30 mg or less.
